(19) United States
(12) Patent Application Publication
(10) Pub. No.: US 2017/0275944 A1
(43) Pub. Date: Sep. 28, 2017

(54) Window Screen Systems

(71) Applicant: Christopher LaPlaca, Chicago, IL (US)

(72) Inventor: Christopher LaPlaca, Chicago, IL (US)

(21) Appl. No.: 15/467,149

(22) Filed: Mar. 23, 2017

Related U.S. Application Data
(60) Provisional application No. 62/311,976, filed on Mar. 23, 2016.

(51) Int. Cl. E06B 9/54

(52) U.S. Cl. CPC E06B 9/54; E06B 2009/543; E06B 2009/528

(57) ABSTRACT

The present disclosure is directed to a window screen system for use with casement, hopper, awning, utility window designs to prevent dirt, debris, and insects from entering into the interior of the unit. The system can be installed on existing window frames to provide screen protection only when the window is open and a screen is needed. As such, a user can have a clear view out of the glass window without the unsightliness, distortion, or solar blockage that a traditional “always visible” screen causes.

### BACKGROUND OF THE INVENTION

The present invention relates to a window screen apparatus. More specifically, the present invention relates to an apparatus that can be used to place a screen on casement windows and the like.

Many condominiums, apartments, and standalone homes feature windows that cannot accommodate a traditional window screen. One common example is that of casement windows, which push or pull inwards or outwards to open (and move the opposite direction to close). This inward and outward movement prevents the use of traditional full window screens that run parallel to windows; commonly seen with sash windows that feature an alternative push up/pull down movement.

While both methods of window opening have their advantages, a drawback of casement windows and other windows, which cannot accommodate a traditional screen, is the inability to stop bugs and other pests from entering a dwelling while the window is open. In the United States, the entrance of such pests into the home is presently an annoyance that has the potential to become a serious public health concern with the proliferation of diseases transmitted by such pests. Additionally, globally, mosquito transmitted diseases are the number one cause of death in many countries.

Accordingly, there is a need for a window screen apparatus that can be used with casement windows and the like.

### BRIEF SUMMARY OF THE INVENTION

To meet the needs described above the present disclosure is directed to a window screen system for use with windows to prevent dirt, debris, and insects from entering into the interior of the unit. The window screen system is particularly useful for hopper, awning, tilt and turn, and utility window designs.

In an embodiment, the window screen system includes a window assembly including a permanent window frame and a movable window frame, wherein the permanent window frame includes a perimeter including a permanent bottom frame portion, a permanent first side frame portion, a permanent second side frame portion, and a permanent top frame portion, wherein the movable window frame includes a perimeter including a movable bottom frame portion, a movable first side frame portion, and a movable second side frame portion, and a movable top frame portion, wherein the movable window frame can move from a closed position to an open position, wherein in the closed position the perimeter of the movable window frame is in contact with the perimeter of the permanent window frame, wherein in the open position at least a portion of the perimeter of the movable window frame is not in contact with at least a portion of the permanent window frame; a rod system including at least one rod, wherein the rod system extends along a portion of the perimeter of the permanent window frame; and a mesh screen extending from the rod system to the movable window frame, wherein upon the movable window frame moving from the closed position to the open position, the mesh screen covers a gap created between the permanent window frame and the movable window frame.

In an embodiment, the window screen system includes a window assembly including a permanent window frame and a movable window frame, wherein the permanent window frame includes a perimeter including a permanent bottom frame portion, a permanent first side frame portion, a permanent second side frame portion, and a permanent top frame portion, wherein the movable window frame includes a perimeter including a movable bottom frame portion, a movable first side frame portion, and a movable second side frame portion, and a movable top frame portion, wherein the movable window frame can move from a closed position to an open position, wherein in the closed position the perimeter of the movable window frame is in contact with the perimeter of the permanent window frame, wherein in the open position at least a portion of the perimeter of the movable window frame is not in contact with at least a portion of the permanent window frame; an installed window frame configured to attach to at least a portion of the permanent window frame; a rod system attached to the installed window frame, wherein the rod system includes at least one rod extending along a portion of the perimeter of the installed window frame; and a mesh screen extending from the rod system to the movable window frame, wherein upon the movable window frame moving from the closed position to the open position, the mesh screen covers a gap created between the permanent window frame and the movable window frame.

An advantage of the present system is a screen that can be used with casement windows that keeps out bugs and other pests such as birds or vermin. While in America these creatures may pose an annoyance, elsewhere in the world these animals can threaten human life and spread many diseases. The screen system engages with casement windows, which typically do not have a screen system available.

Another advantage of the present is the system is not only keeping pests out, but also keeps pets and children within a residence. While not the strongest deterrent, a screen on a window that would otherwise be a wide-open gap may prevent pets and children from falling out of the window.

Yet another advantage of the present system is that it provides the potential for cost savings in the form of less electricity used to heat and cool a dwelling. Opening the windows when the weather permits prevents the need to run an HVAC system, lowering electricity costs and well as providing fresh air to a domicile. Such action is impractical for casement windows in areas with large pest populations since the dwelling will become inundated with bugs, etc. since no screen can readily be placed on this type of window. The present invention allows such a screen to be placed on windows that traditionally cannot accommodate one.

Still yet another advantage of the present system is that the low-profile design of the window screen apparatus does not block the view of the window on which the apparatus is placed. In many situations, casement windows are used over sash windows not only because of space requirements, but because casement windows allow for unimpeded views. Sash windows featuring a screen obstruct the window's view with a screen that also blocks sunlight. The present invention features a screen that covers the gap created by an open window, without the need to have the screen permanently visible over the window.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is an embodiment of the screen system engaged with a window frame.

FIG. 2 is an exploded view of an embodiment of the screen system engaged with a window frame.

FIG. 3 is a perspective view of an embodiment of the screen system engaged with an opened window.

FIGS. 4-5 are perspective views of the screen system including a housing for the central and side rods.

FIG. 6 is a front view of a top corner housing engaged with a side rod.

FIG. 7A is a perspective view of a window frame including a locking mechanism.

FIG. 7B is an embodiment of the screen system engaged with a window including a locking mechanism.

FIGS. 8A-8C are diagrams of various connection methods for the central portion to the side portion of the mesh screen.

### DETAILED DESCRIPTION OF THE INVENTION

The present disclosure is directed to a window screen system for use with windows to prevent dirt, debris, and insects from entering into the interior of the unit. Although the figures and examples typically illustrate an awning and/or hopper type of window, the window screen system is also useful for casement, utility, single hung, double hung, and tilt and turn window designs, among others. The system can be installed on existing window frames to provide screen protection only when the window is open and a screen is needed. As such, a user can have a clear view out of the glass window without the unsightliness, distortion, or solar blockage that a traditional “always visible” screen causes. The system disclosed is also applicable to windows that slide up and down, wherein the mesh screen extends from only the bottom portion of the permanent window frame to the bottom portion of the movable window frame, such that the screen is only seen or active when the window is slid open.

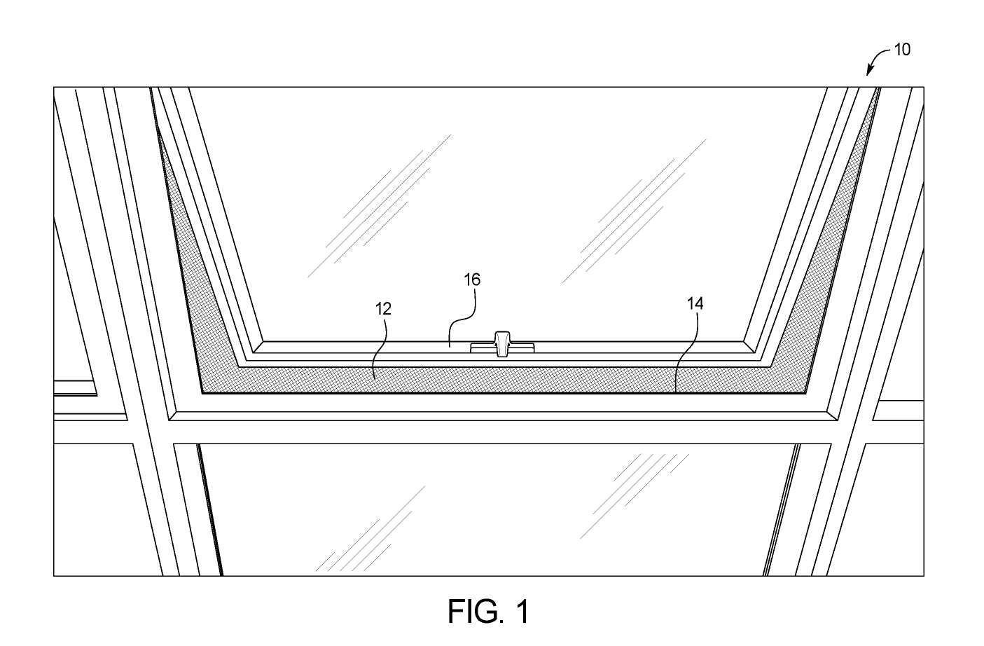

The window screen system engages with a conventional window frame. As shown in FIG. 1, the screen system 10 includes a mesh screen 12 that extends between the original window frame 14 and the moveable window frame 16. In an example, the mesh screen 12 can be provided to a user in a fixed size that covers a gap between the permanent window frame and the movable window frame when the movable window frame is open. As such, the user can manually install the fixed size mesh screen after opening the window. The installment can include any attachment mechanism to the permanent and movable window frames, including, but not limited to, adhesives, hooks, snaps, hook and loop systems, clasps, among others. When the user desires to close the window, the mesh screen can be easily removed and then the window can be closed.

In an example, the mesh screen 12 is coiled around a rod system (e.g., a central rod 20 and side rods 21, 22) connected to the permanent window frame, wherein the mesh screen extends from the rod system to the edges of the moveable window frame 16. As a result, when the window opens, the mesh screen 12 uncoils covering the gap created by the open window. When the moveable window frame is in a closed position, the majority of the mesh screen is coiled around the central and side rods.

The central rod 20 and side rods 21, 22 can include a spring-loaded coil mechanism that keeps the screen taut while the window is open and the mesh screen is extended to cover the gap. In addition, with a spring loaded coil mechanism, the mesh screen automatically rewinds itself around the coil when the user closes the window. Additional reinforcements may also be used to keep the screen taut for windows that open widely. When a user closes the window, and the screen is rewound onto the coil yet still attached to the movable window frame, such when the window is closed, the system provides a subtle appearance. For example, the coiling rods (e.g., 20, 21, 22) can include a retraction mechanism that can include a torsional spring and/or torsional shaft. Torsional springs are designed to resist forces in a rotational manner, as opposed to a linear motion. By pushing the window open, the mesh screen uncoils from the torsional shaft and the torsional spring creates a counter force in the opposition direction of the uncoiling to maintain the mesh screen taut between the coiling rod and the movable window frame. As a result of the taut configuration, the mesh screen does not flap in the wind when the window is open.

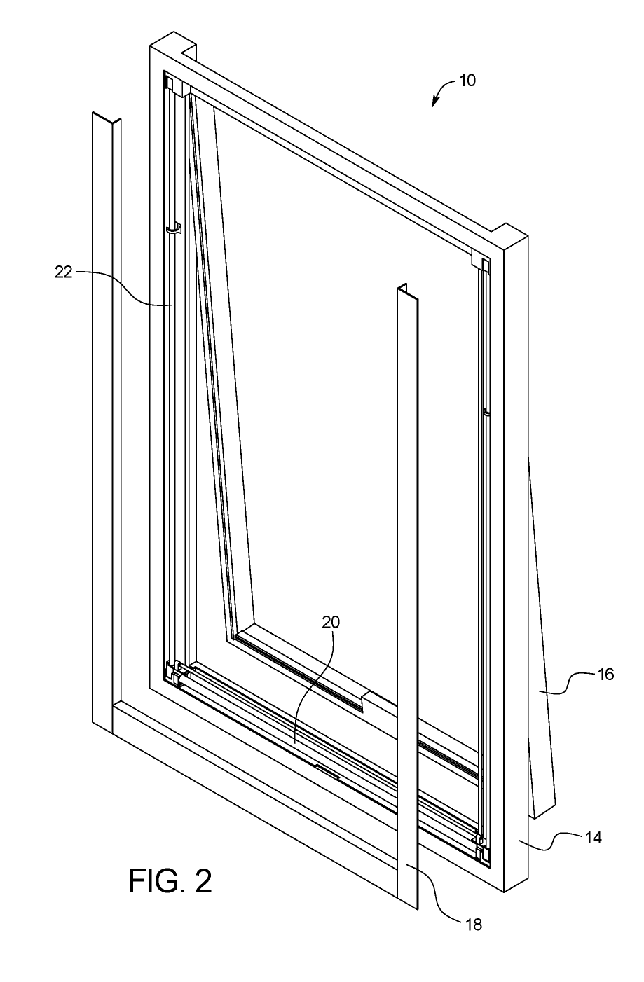

As shown in FIG. 2, the system 10 can include an installed frame 18 that can attach to the existing window frame 14 to visually conceal the central rod 20 and side rods 21, 22 that hold the mesh screen 12. The installed frame 18 can be made of any suitable material including plastic, aluminum, or rubber. The installed frame 18 material may be colored to match the window frame on which they are being placed to provide a uniform look. The adhesive used may also be any that is suitable for adhering the installed frame to a window frame but also may utilize adhesive, which leaves no residue when removed. The overall size of the apparatus may change depending on a given window's size and how far the window opens. The central and side rods can be pressure fit into the existing window frame 14 or to the installed window frame 18.

Although the figures generally refer to examples wherein the mesh screen can coil and uncoil from a cylindrical rod, it should be understood than that the mesh screen can go from any compacted version when the window is closed to an expanded version when the window is open. In an example, the mesh screen can be folded in an accordion type fashion while the window is closed, and then expands and unfolds when the window is open.

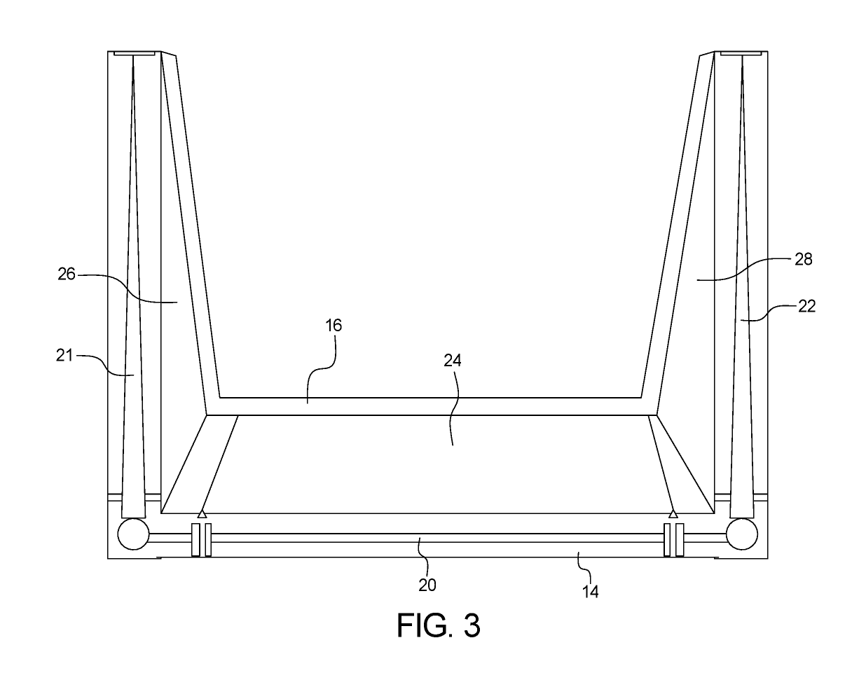

In an example, as shown in FIG. 3, the mesh screen 12 can include a central portion 24, a first side portion 26, and second side portion 28. The central portion 24 can extend from bottom portion of the original window frame or the installed frame, wherein the first side portion 26 and second side portion 28 extend from the sides of the window frame or installed frame. When the window is opened, the central portion 24 unwinds from the central rod, the first side portion unwinds from the first side rode, and the second side portion unwinds from the second side rod. Once the mesh portions are unwound and extended, the edge of the first side portion can join with the first side edge of the central portion, and the edge of second side portion can join with the second side edge of the central portion, thereby creating a continuous mesh screen across the opening of the opened window.

In an example, the central portion 24 extends from a bottom first corner of the window frame and to a bottom second corner of the window frame. The first side portion 26 can extend from a first bottom corner of the window frame to a first top corner of the window frame. Similarly, the second side portion 28 can extend from a second bottom corner of the window frame to a second top corner of the window frame.

Alternatively, in an example, the central portion 24 extends beyond the bottom first corner of the window frame and partially up the first side of the window, and extends beyond the bottom second corner of the window and up a portion of the second side of the window. The first side portion 26 and second side portion can connect to the ends of the central portion to the respective top corners of the window. As a result, the edges of the central portion 24 and side portions are not joined at the corner (e.g., perpendicular), and instead are joined in the same plane. Alternatively, the first side portion 26 and second side portion 28 can extend beyond the respective corners to attach to the central portion 24 (i.e., the central portion does not extend from the first bottom corner to the second bottom corner).

The central and side rods can be made of aluminum and a plastic insert can be included inside the rod that can have a hollow hexagonal channel. A spring is attached to the hexagonal end piece and provides torque in a direction opposite to the direction that the rod is rotated. The central rod can be housed in a bottom bearing housing wherein the bottom rod is inserted in a needle bearing. A needle bearing allows the rod to rotate freely with minimal friction and counteracts any radial forces on the rod. An edge of the central portion of the mesh screen can be adhered to the central rod, for example, via tape, glue, hook and loop adhesives, among other adhesives.

In an example, the first side rod 21 and second side rod 22 can be cylindrical or conical. If the side rods are conical, the diameter of the base of the conical rod, positioned at the respective bottom corner of the window frame, is greater than the diameter of the cross section of the top portion cylindrical rod, positioned at the respective top corners of the window frame. The conical side rods can allow the mesh screen to cover the triangular shape created when the hopper window is opened. In addition, the conical rod allows for the first side portion of the mesh screen and the second side portion of the mesh screen to be dispensed at a slower or different rate than that of the central portion of the mesh screen.

Alternatively, the side rods 21, 22 can include a bearing assembly and a spring anchoring the rod to the window housing. A needle bearing can be used to combat the bending forces on the rod while a thrust bearing can be used to combat the axial force of the mesh screen. The mesh screen can be attached at the top of the side rod through the use of a clamping or pinning mechanism around the mesh screen. In an example, the clamp and/or pin can be attached to the window housing with a spring. The bottom portion of the side rod can be allowed to rotate freely without interacting with the top of the side rod. The clamped connection at the top of the mesh screen allowed for minimal rotation during extension and retraction of the side portions of the mesh screen. As such the side portions of the mesh screen to be deposited rapidly near the bottom corner of the window frame without any or minimal movement of the side rode at the top corner. In an example, to minimize the bending of the clamp and/or pin when the clamp or pin is rotated when the window opens and the side portion of the mesh screen is extended, a rod and bearing assembly can be used to increase stability and reduce the friction and binding felt upon deploying the side portion of the mesh screen when the window opens. An edge of the side portions of the mesh screen can be adhered to the respective side rods, for example, via tape, glue, hook and loop adhesives, among other adhesives.

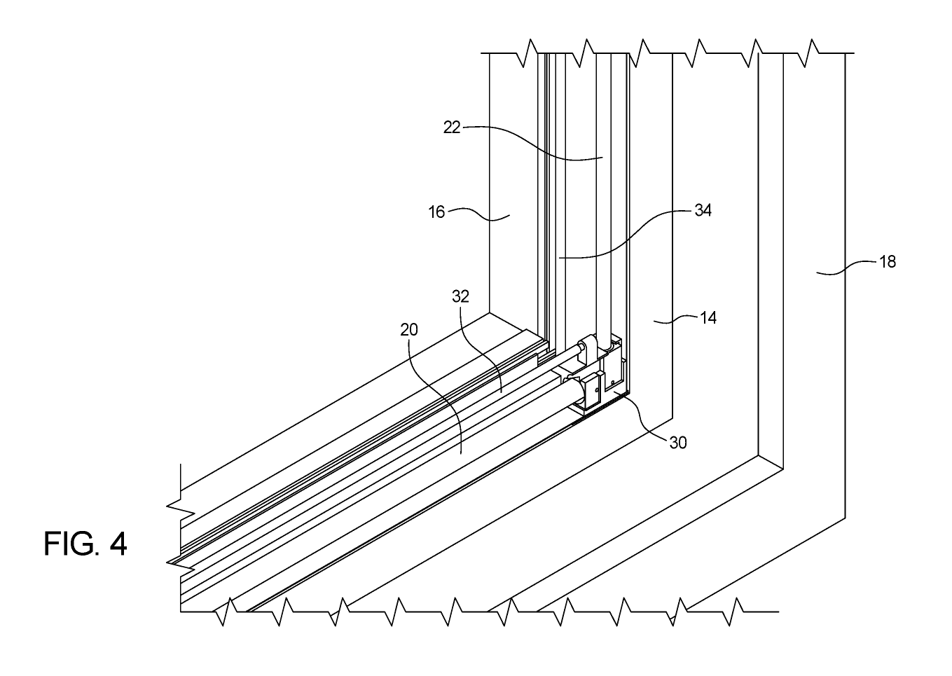

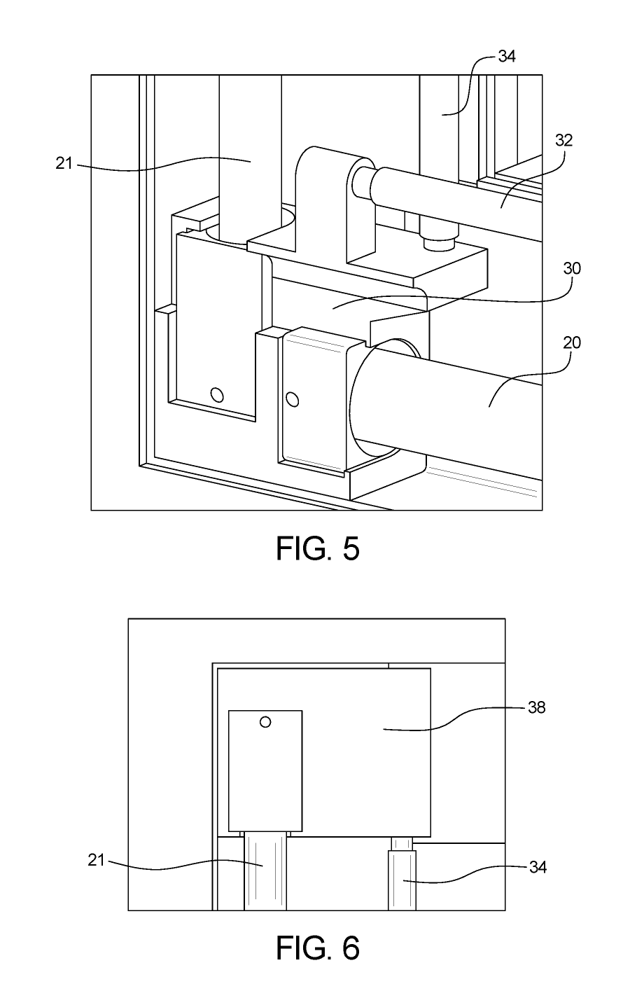

As shown in FIG. 4, a bottom corner rod housing 30 can be positioned in each bottom corner of the original window frame or the installed window frame. As shown in FIG. 5, the first rod housing is configured to house the first end of the central rod 20 and the bottom end of the first side rod 21, and the second rod housing is configured to house the bottom end of the second side rod 22 and second end of the central rod 20. A fixed horizontal rod 32 is positioned above and parallel to the central rod 20, wherein a first end of the fixed horizontal rod 32 is attached to the first rod housing, and a second end of the horizontal rod is attached to the second rod housing. The central portion 24 of the mesh screen extends over the top of the fixed horizontal rod 32 as the central portion 24 of the mesh screen uncoils from the central rod 20. Similarly, vertical rods 34 are positioned parallel to the first and second side rods 21, 22 such that the side portions 26, 28 of the mesh screen extend around the vertical rods as the side portions are uncoiled from the side rods 21, 22. The placement and design of the vertical and horizontal rods allows for the central and side portions of the mesh screen to be uncoiled and extended across the openings in the open window without a large gap between the respective edges of the central and side portions of the mesh screen.

In addition, as shown in FIG. 6, a first and second top corner housing 38 can be positioned at the respective top corners of the original window pane or the installed frame, wherein the top corner housing 38 receives the top ends of the respective side rods 21, 22 and vertical rods 34.

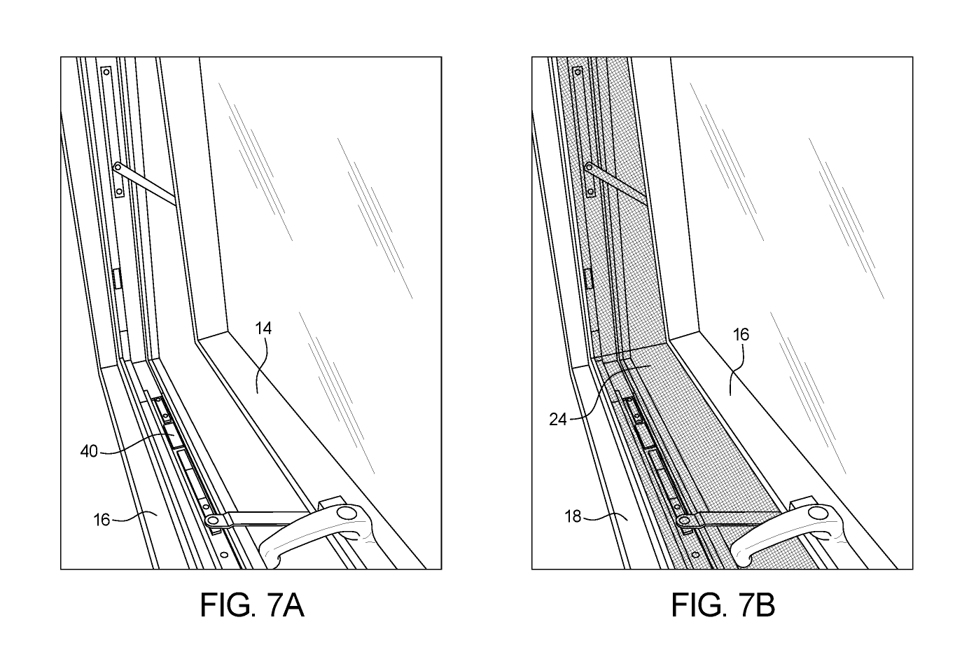

As shown in FIGS. 7A-7B, conventional awning and hopper type windows include an original locking mechanism 40 that prevents the window from closing on its own, and typically automatically activates upon the window opening. An advantage of the mesh screen being separable into the three parts includes a user having access to a locking mechanism that can be activated by a user upon opening the window to keep the window open at the desired degree of openness. If the mesh screen were in one piece, the user would not have access to activate the locking mechanism, as the screen would cover access to the locking mechanism when the window is opened. If the screen is separated into the three parts, a user can access the locking mechanism by retracting the central portion of the mesh screen.

Alternatively, or in addition to, a housing within the installed frame 18 can include a button, lever, or other locking mechanism activator that a user can access to activate the locking mechanism, wherein the locking mechanism activator is mechanically or electrically in communication with the locking mechanism of the window. As a result, the user can activate the locking mechanism originally installed in the window without retracting the mesh screen. For example, the user can activate or deactivate the locking mechanism by a lever (e.g., deactivation arm) that travels underneath the mesh screen, between the screen and the housing, thus, not interfering with the screen and increasing excess wear. Alternatively, or in addition to, the mesh screen can be one continuous piece and/or separated into various portions, yet the mesh screen can be flexible enough for a user to access the original locking mechanism in the window by pushing through the screen to access the locking mechanism.

The mesh screen 12 can include aluminum, nylon, polyester, fiberglass, nylon/spandex blend, or combinations thereof. Typically, a mesh screen comprised of aluminum does not have a fatigue limit, therefore, the repetitive rolling or folding of the screen mesh can induce a break in the material. A mesh screen comprising fiberglass is typically not resistant to UV rays, and may deteriorate after prolonged use. A mesh screen comprising nylon and/or polyester are less likely to fatigue and are much more resilient, thus, having a longer lifetime. A nylon screen mesh and a polyester screen mesh can provide elasticity to the screen mesh. A mesh screen comprising polyester can have a fairly high glass transition temperature, and can exhibit less than desirable properties in colder temperatures. A mesh screen comprising a vinyl-coated polyester has optimal fatigue properties, as well as functional over a wide variety of temperatures.

In an example, the mesh screen may be aluminum insect screens. In other embodiments, the screens may be porous, stretchy fabric with sufficient porosity to permit airflow, but pore sizes that are sufficiently small to exclude insects from entry into a building.

The edges of the mesh portions can include any suitable attachment means. For example, the edges can include a magnetic strip (or a series of magnetic strip pieces), tape, a series of magnets placed along the edges encased, hooks and loops, hooks and clasps, buttons, snaps, among others. The series of magnets along the edges can be placed within a fabric or two layers of the mesh screen. In an example, the magnets included neodymium magnets.

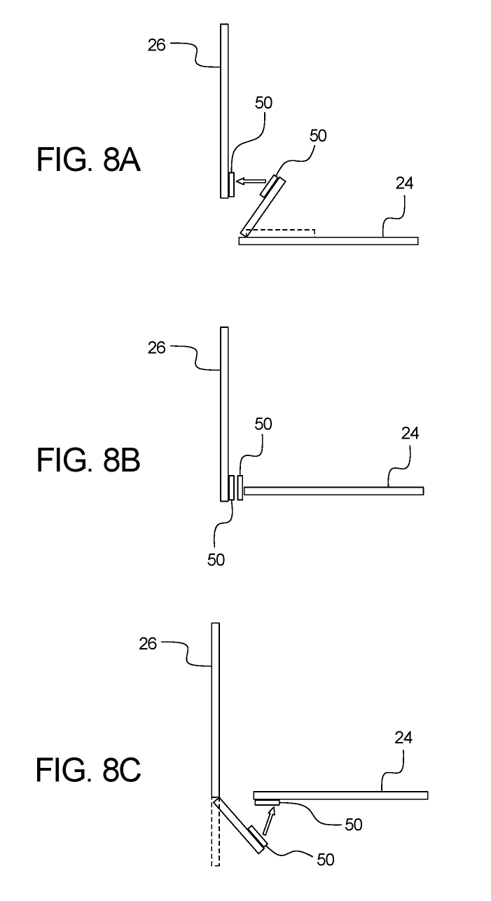

The magnets 50 along the edges of the portions of mesh screen can be manually coupled as or after the window is opened. Alternatively, the magnets 50 can automatically couple as the mesh portions are uncoiled and the window is opened. For example, as shown in FIG. 8A, the central portion 24 can be bent upward and couple to the magnets 50 on the edge of the side portion 26, 28. As shown in FIG. 8B, the magnets 50 of the central portion 24 can be perfectly aligned with the magnets 50 on the edge of the side portion 26, 28. As shown in FIG. 8C, the side mesh portions 26, 28 can flip upward to meet the edges of the central portion 24. The flipping in FIGS. 8A and 8C can be achieved by attaching the side mesh portions perpendicularly at the window pane such that the bottom of the side portions are uncoiled at an angle.

It should be understood that notwithstanding the majority of examples include the screen system in conjunction with a window, the present system can also be used for any number of applications including, but not limited to, any other type of window, door, entryway, aperture, or porthole. Further, although the majority of the figures refer to a window wherein the moving window frame opens out to the exterior, it should be understood that the system is applicable to windows that open to the interior of the unit.

It should be noted that various changes and modifications to the presently preferred embodiments described herein will be apparent to those skilled in the art. Such changes and modifications may be made without departing from the spirit and scope of the present invention and without diminishing its attendant advantages.

1. A window screen system comprising:
a window assembly including a permanent window frame and a movable window frame,
wherein the permanent window frame includes a perimeter including a permanent bottom frame portion, a permanent first side frame portion, a permanent second side frame portion, and a permanent top frame portion,
wherein the movable window frame includes a perimeter including a movable bottom frame portion, a movable first side frame portion, and a movable second side frame portion, and a movable top frame portion,
wherein the movable window frame can move from a closed position to an open position, wherein in the closed position the perimeter of the movable window frame is in contact with the perimeter of the permanent window frame, wherein in the open position at least a portion of the perimeter of the movable window frame is not in contact with at least a portion of the permanent window frame;
a rod system including at least one rod, wherein the rod system extends along a portion of the perimeter of the permanent window frame; and
a mesh screen extending from the rod system to the movable window frame, wherein upon the movable window frame moving from the closed position to the open position, the mesh screen covers a gap created between the permanent window frame and the movable window frame.

2. The window screen system of claim 1, wherein the rod system includes
a central rod extending from the permanent first side frame portion to the permanent second side frame portion, wherein the central rod is positioned parallel to the permanent bottom frame portion;
a first side rod extending from the permanent bottom frame portion to the permanent top frame portion, wherein the first side rod is positioned parallel to the permanent first side frame portion; and
a second side rod extending from the permanent bottom frame portion to the permanent top frame portion, wherein the second side rod is positioned parallel to the permanent second side frame portion,
wherein the mesh screen extends from the central rod to the movable bottom window frame portion, from the first side rod to the movable first side window frame, and from the second side rod to the movable second side window frame portion, wherein upon the movable window frame pivoting from the closed position to the open position, the mesh screen covers a gap created between the permanent window frame and the movable window frame.

3. The window screen system of claim 2, wherein the mesh screen includes
a central mesh screen portion extending from the central rod to the movable bottom frame portion, wherein upon the movable window frame pivoting from the closed position to the open position, the central mesh screen uncoils from the central rod to cover a central gap created between the permanent bottom window frame and the movable bottom window frame;
a first side mesh screen portion extending from the first side rod to the movable first side frame portion, wherein upon the movable window frame pivoting from the closed position to the open position, the first side mesh screen uncoils from the first side rod to cover a first side gap created between the permanent first side window frame and the movable first side window frame; and
a second side mesh screen portion extending from the second side rod to the movable second side frame portion, wherein upon the movable window frame pivoting from the closed position to the open position, the second side mesh screen uncoils from the second side rod to cover a second side gap created between the permanent second side window frame and the movable second side window frame.

4. The window screen system of claim 3, wherein a first side bottom edge of the first side mesh screen portion includes a plurality of magnets, wherein a second side bottom edge of the second side mesh screen portion includes a plurality of magnets, wherein a first side central edge of the central mesh screen portion includes a plurality of magnets, wherein a second side central edge of the central mesh screen portion includes a plurality of magnets,
wherein when the movable window frame is in the open position, the first side bottom edge of the first side mesh screen portion magnetically connects to the first side central edge of the central mesh screen portion,
wherein when the movable window frame is in the open position, the second side bottom edge of the second side mesh screen portion magnetically connects to the second side central edge of the central mesh screen portion.

5. The window screen system of claim 1, wherein the rod system includes at least one rod including a spring coil mechanism, wherein the spring coil mechanism is configured to maintain force on the mesh screen in the direction towards the at least one rod.

6. The window screen system of claim 1, wherein the mesh screen is coiled around the at least one rod of the rod system, wherein when the movable window frame pivots from the closed position to the open position, the mesh screen partially uncoils from the at least one rod.

7. The window screen system of claim 1, wherein the mesh screen includes aluminum.

8. The window screen system of claim 1, wherein the mesh screen includes vinyl coated polyester.

9. A window screen system comprising:
a window assembly including a permanent window frame and a movable window frame, wherein the permanent window frame includes a perimeter including a permanent bottom frame portion, a permanent first side frame portion, a permanent second side frame portion, and a permanent top frame portion,
wherein the movable window frame includes a perimeter including a movable bottom frame portion, a movable first side frame portion, and a movable second side frame portion, and a movable top frame portion,
wherein the movable window frame can move from a closed position to an open position, wherein in the closed position the perimeter of the movable window frame is in contact with the perimeter of the permanent window frame, wherein in the open position at least a portion of the perimeter of the movable window frame is not in contact with at least a portion of the permanent window frame;
an installed window frame configured to attach to at least a portion of the permanent window frame;
a rod system attached to the installed window frame, wherein the rod system includes at least one rod extending along a portion of the perimeter of the installed window frame; and
a mesh screen extending from the rod system to the movable window frame, wherein upon the movable window frame moving from the closed position to the open position, the mesh screen covers a gap created between the permanent window frame and the movable window frame.

10. The window screen system of claim 9, wherein the rod system includes
a central rod extending from an installed first side frame portion to an installed second side frame portion, wherein the central rod is positioned parallel to an installed bottom frame portion;
a first side rod extending from the installed bottom frame portion to an installed top frame portion, wherein the first side rod is positioned parallel to the installed first side frame portion; and
a second side rod extending from the installed bottom frame portion to the installed top frame portion, wherein the second side rod is positioned parallel to the installed second side frame portion,
wherein the mesh screen extends from the central rod to the movable bottom window frame portion, from the first side rod to the movable first side window frame, and from the second side rod to the movable second side window frame portion, wherein upon the movable window frame pivoting from the closed position to the open position, the mesh screen covers a gap created between the permanent window frame and the movable window frame.

11. The window screen system of claim 10, wherein the mesh screen includes
a central mesh screen portion extending from the central rod to the movable bottom frame portion, wherein upon the movable window frame pivoting from the closed position to the open position, the central mesh screen uncoils from the central rod to cover a central gap created between the permanent bottom window frame and the movable bottom window frame;
a first side mesh screen portion extending from the first side rod to the movable first side frame portion, wherein upon the movable window frame pivoting from the closed position to the open position, the first side mesh screen uncoils from the first side rod to cover a first side gap created between the permanent first side window frame and the movable first side window frame; and
a second side mesh screen portion extending from the second side rod to the movable second side frame portion, wherein upon the movable window frame pivoting from the closed position to the open position, the second side mesh screen uncoils from the second side rod to cover a second side gap created between the permanent second side window frame and the movable second side window frame.

12. The window screen system of claim 11, wherein a first side bottom edge of the first side mesh screen portion includes a plurality of magnets, wherein a second side bottom edge of the second side mesh screen portion includes a plurality of magnets, wherein a first side central edge of the central mesh screen portion includes a plurality of magnets, wherein a second side central edge of the central mesh screen portion includes a plurality of magnets,
wherein when the movable window frame is in the open position, the first side bottom edge of the first side mesh screen portion magnetically connects to the first side central edge of the central mesh screen portion,
wherein when the movable window frame is in the open position, the second side bottom edge of the second side mesh screen portion magnetically connects to the second side central edge of the central mesh screen portion.

13. The window screen system of claim 9, wherein the rod system includes at least one rod including a spring coil mechanism, wherein the spring coil mechanism is configured to maintain force on the mesh screen in the direction towards the at least one rod.

14. The window screen system of claim 9, wherein the mesh screen is coiled around the at least one rod of the rod system, wherein when the movable window frame pivots from the closed position to the open position, the mesh screen partially uncoils from the at least one rod.

15. The window screen system of claim 9, wherein the mesh screen includes aluminum.

16. The window screen system of claim 9, wherein the mesh screen includes vinyl coated polyester.
